(19) United States
(12) Patent Application Publication
(10) Pub. No.: US 2005/0151762 A1
(43) Pub. Date: Jul. 14, 2005

(54) Image recording apparatus with slidably opening scanner bed

(76) Inventors: Frederick C. Griesemer, Lexington, KY (US); Daniel R. LaBar, Lexington, KY (US); Michael A. Marra III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/757,283

(22) Filed: Jan. 14, 2004

(51) Int. Cl. H04N 1/034

(52) U.S. Cl. 347/3

(57) ABSTRACT

An image recording apparatus with slidably opening scanner bed is provided. The scanner bed includes an interface for releasing the scanner bed from a first position. The scanner bed may be biased by an actuation device in order to urge the scanner bed when the interface is activated from the first position to a second position. The scanner bed preferably is slidably positioned on a base housing of an image recording device and, when actuated to a second position reveals a cartridge changing station within the base housing.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an image recording apparatus including an ink jet printer and optical scanner. More particularly, the present invention relates to an image recording apparatus having a slidably opening scanner bed which reveals an inkjet cartridge changing station.

2. Description of the Related Art

All-in-one machines or multi-function peripherals (hereinafter “MFPs”) typically perform functions such as printing, scanning, copying, and faxing in either a stand alone fashion or in conjunction with a personal computer and define a growing market for peripheral devices. These devices eliminate clutter in a business or home office by combining the desirable functionality of various machines into a single unit, while maintaining an affordable cost. Various all-in-one machines currently in the marketplace use thermal inkjet technology as a means for printing received fax documents, original documents, and copied or scanned images or text.

Thermal inkjet printing devices utilize consumable inkjet cartridges in fluid communication with a printhead to record text and images on a print media. The printhead typically moves on a carriage relative to the media path and a control system activates the printhead to eject ink droplets onto the print media. In order to replace consumed inkjet cartridges, existing multi-function peripherals provide a hinged housing allowing pivoting motion of the scanner bed to access the empty inkjet cartridge. This design is referred to as a clam-shell design. However, this method of inkjet cartridge replacement has disadvantages. First, a user is required to place a hand in a small, dark target area to access the inkjet cartridges. Second, if the target area is increased to alleviate the first problem, the user may contact and damage various parts including a carrier encoder strip, drive belt, guide shaft, or flat flexible cable. Thus, a third problem is the requirement of a cover to inhibit user contact with parts adjacent the printhead carriage and inkjet cartridge. These covers increase the cost of manufacturing the devices. Fourth, a user may become confused and open the scanner lid, rather than the scanner bed, which may pivot on a parallel axis as the scanner bed. Finally, a scanner bed kickstand or prop may be necessary to hold the scanner bed up during maintenance or replacement of the inkjet cartridges incurring the expense of yet another additional part. Given the foregoing deficiencies, it will be appreciated that a multi-function peripheral is needed allowing easier access to and replacement of thermal inkjet cartridges.

### SUMMARY OF THE INVENTION

With regard to the foregoing, one embodiment of the invention eliminates the oversights, difficulties, and disadvantages of the prior art by providing a scanner bed which slides horizontally a preselected distance relative to a base housing in order to reveal an ink cartridge changing station.

An object of the present invention is to provide an improved opening mechanism for a scanner bed of a multi-function peripheral device.

An additional object of the present invention is to provide a horizontally slidable scanner bed for a multi-function peripheral device.

Another object of the present invention is to eliminate the use of a props or kickstands associated with clam-shell type multi-function peripherals.

Yet another object of one embodiment of the present invention is to decrease the size of covers currently used with clam-shell type scanner beds.

According to an embodiment of the invention, an image recording apparatus is provided having a base housing and a scanner bed slidably positioned on the base housing. A scanner lid is hingedly attached to the scanner bed along at least one side of the scanner bed. The scanner bed includes integrally molded rails depending from a lower surface thereof which slidably engage tracks on a base housing cover providing a horizontal sliding motion for the scanner bed relative to the base housing. The scanner bed may be biased by a linear spring or other mechanism or design to urge the scanner bed from a first operating position to a second cartridge changing position. When the scanner bed is slidably disposed in the second position, a cartridge changing station is revealed wherein a user can easily replace consumed inkjet cartridges. The base housing may further include a retaining hook to retain the scanner bed in the first operating position. The scanner bed may include a button extending downwardly through the scanner bed which engages the retaining hook allowing the biasing spring to urge the scanner bed to the second position thereby revealing the cartridge changing station.

### BRIEF DESCRIPTION OF THE DRAWINGS

FIG. 1 is a perspective view of a multi-function peripheral of an embodiment of the present invention with the scanner bed shown in a closed position and a lid shown in an open position;

FIG. 2 is a perspective view of the peripheral of FIG. 1 with the scanner bed shown in the open position;

FIG. 3 is an exploded perspective view of the peripheral of FIG. 1;

FIG. 4 is a perspective view of the printing component illustrating an embodiment of the present invention;

FIG. 5 is a partial cut-away of FIG. 1 to clearly show a biasing spring in an extended position;

FIG. 6 is a lower perspective view of the scanner bed of an embodiment of the present invention;

FIG. 7 is a perspective view of a slide lock for use in an embodiment of the present invention;

FIG. 8 is a perspective view depicting an alternative sliding mechanism embodiment of the present invention;

FIG. 9 is a second alternative sliding mechanism embodiment of the present invention; and,

FIG. 10 is yet another alternative sliding mechanism embodiment of the present invention.

### DETAILED DESCRIPTION

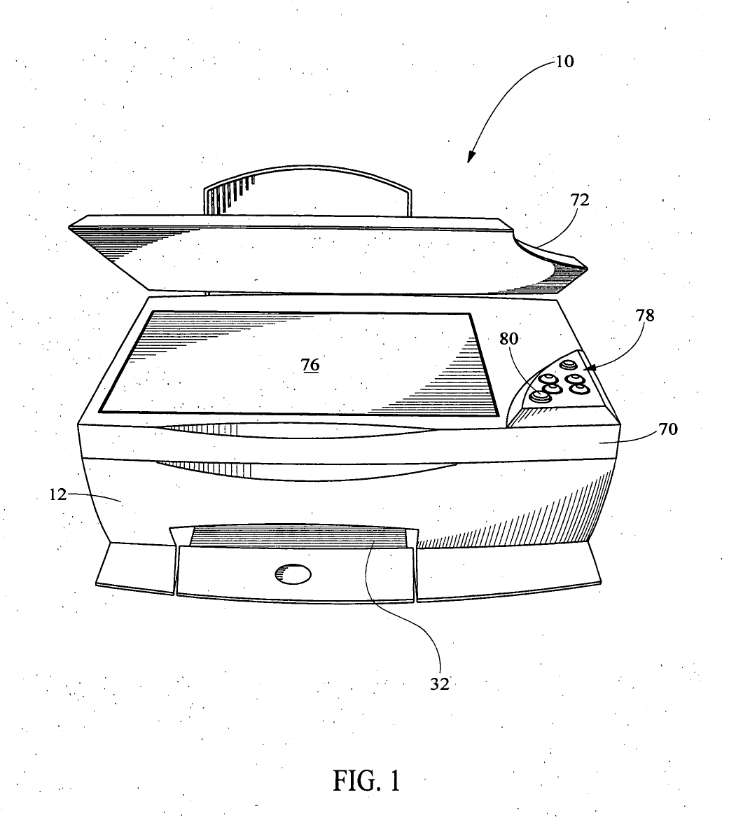

Referring now in detail to the drawings, wherein like numerals indicate like elements throughout the several views, there is shown in FIGS. 1 through 10 various aspects of an image recording apparatus and more specifically an image recording apparatus having at least scanning and printing functions, also known as a multifunction peripheral or all-in-one peripheral device. The image recording apparatus includes a base housing and a scanner bed which is horizontally slidable relative to the base housing in order to reveal a cartridge changing station within the base housing. The various embodiments of the present invention provides a user with a novel structure for changing an inkjet cartridge in a multi-function peripheral device.

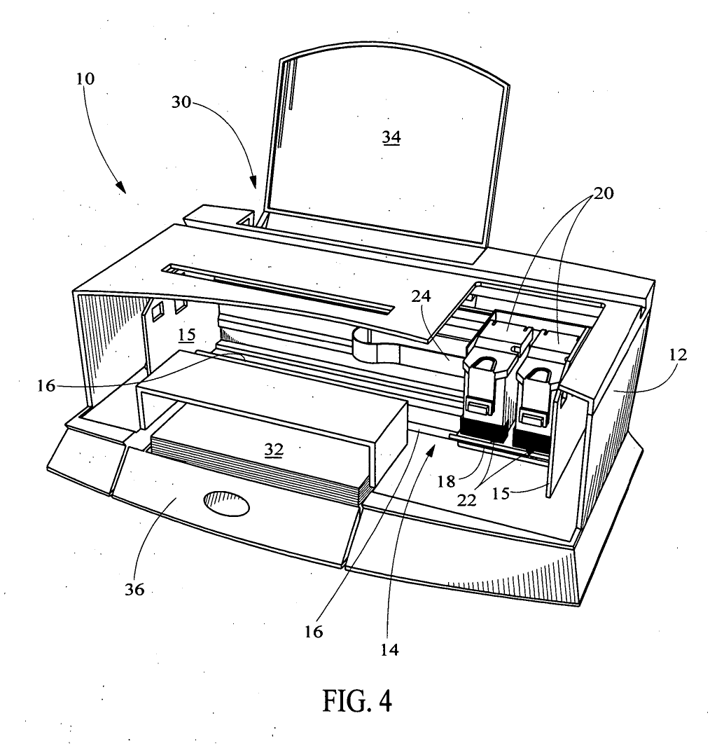

Referring initially to FIG. 1, an image recording apparatus 10 is shown in a perspective view including a base housing 12 and a slidable scanner bed 70 slidably disposed along an upper portion of the base housing 12. The base housing 12 includes a printing component 14, best seen in FIG. 4, for the image recording apparatus 10.

Referring to FIG. 4, the printing component 14 is shown generally as a thermal inkjet print device. The printing component 14 has at least one carrier guide shaft 16 extending between opposed sides of frame members 15 within the base housing 12. Slidably positioned on the first and second carrier guide shafts is a carrier 18 which may be urged by electrical motor through a horizontal scanning axis along the carrier guide shafts 16 between side members 15 and within a print zone. The travel path of the carrier 18 is substantially perpendicular to a path defined by a print media 32 or paper path described hereinafter. Electrical signals are provided by a print controller to a carrier drive, not shown, causing the carrier 18 to reciprocate along the carrier guide shafts 16.

The carrier 18 has at least one receiving station 22 for an ink cartridge 20. Preferably there are at least two ink cartridges 20, a single color ink container and a tri-color ink container. For example, the tri-color ink container may contain cyan, magenta, and yellow inks and the single color ink container may contain black ink. Alternatively however, two or more single color inks cartridges may be used or two or more tri-color ink cartridges may be used depending on the needs of the user. The ink cartridges 20 are each in fluid communication with a printhead, not shown, for ejecting ink to a print media 32. More specifically, electrical signals are provided to the printhead by a flexible flat cable or ribbon cable 24 providing signals to the carrier 18 and printhead to selectively activate the printhead and nozzles therein to eject ink onto the print media 32.

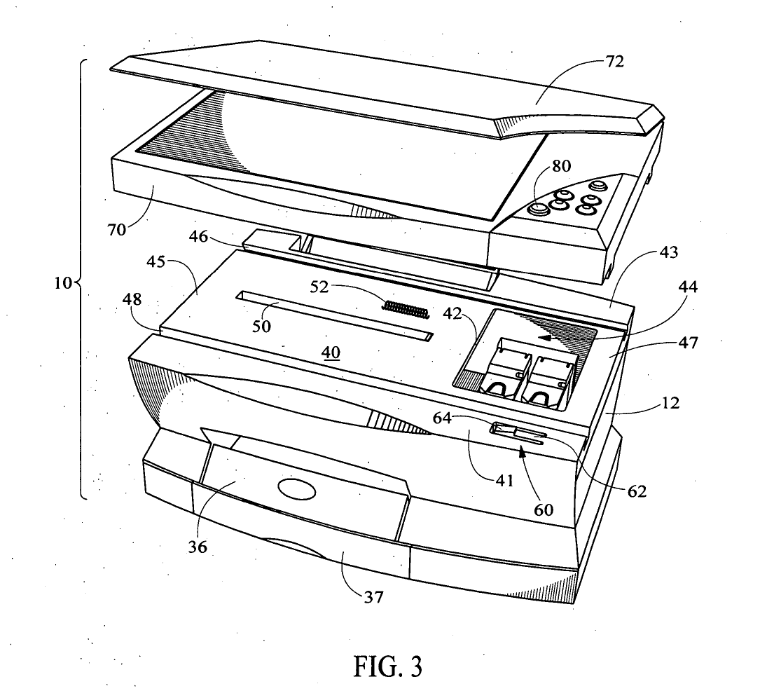

The printing component 14 further comprises a paper advance mechanism, not shown, comprising for instance a motor, a drive, and at least one roller for indexing the print media 32 through the print zone. The paper advance mechanism includes a feed tray 34 located in the present embodiment on a rear portion of the image recording apparatus 10. The feed tray 34 extends downwardly into the base housing 12 at a rear portion of the multifunction peripheral 10 (shown in FIG. 3). Between the feed tray 34 and an output tray 36 is the print zone wherein the printhead and print media 32 are in close proximity as the print media 32 is indexed through the printing component 14 and ink is ejected by the printhead onto the print media 32. According to the present illustrative embodiment, an L-path paper feed is shown and termed L-path because the paper is standing substantially upright but is indexed through the print zone to the output tray 36 at a front lower portion of the base housing 12 wherein the paper is substantially horizontally disposed. Alternatively however, a C-path paper feed may be utilized with the present invention wherein a feed tray is positioned within a front portion of the base housing above or below the output tray. According to the C-path paper feed wherein the print media is substantially horizontally positioned in the feed tray, pulled through the printing component, turned toward the print zone, and guided out of the printing component into the output tray 36 wherein the print media is also substantially horizontally positioned in order to define a substantially C-shaped path.

The base housing 12 shown in FIG. 3 is configured to include an upper tray 36 and lower tray 37 on a front surface of the housing 12, as required to form the C-path paper feed. According to this alternative embodiment, the upper tray 36 may be an output tray as previously described or an input tray with the lower tray 37 being oppositely configured.

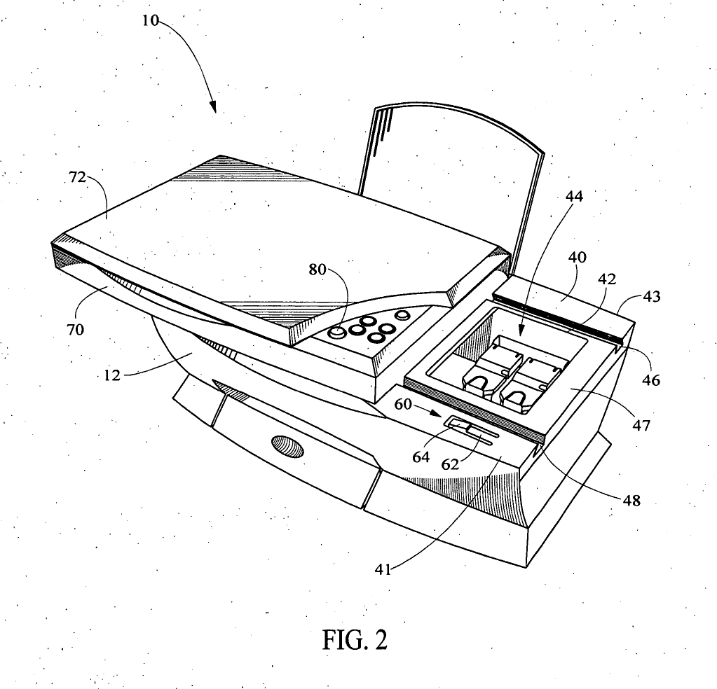

Referring now to FIGS. 2 and 3, according to a first embodiment a sliding mechanism is defined by a lower portion of the slidable scanner bed 70 and the base housing 12 in order to provide the sliding action between the base housing 12 and the scanner bed 70 for changing of an ink cartridge 20. Base housing 12 includes a plurality of sidewalls defining an enclosure and a base housing cover 40 comprising a front edge portion 41, a rear edge portion 43, and opposed side edges 45, 47. The cover 40 also includes a window or aperture 42 therein revealing a cartridge changing station 44. Cover 40 or the upper portion of the base housing 12 includes at least one track, preferably first and second tracks 46, 48. Tracks 46, 48 are substantially parallel and may extend fully or partially between opposed side edges 45, 47 of the cover 40. Tracks 46, 48 may be formed in or on cover 40 or base housing 12.

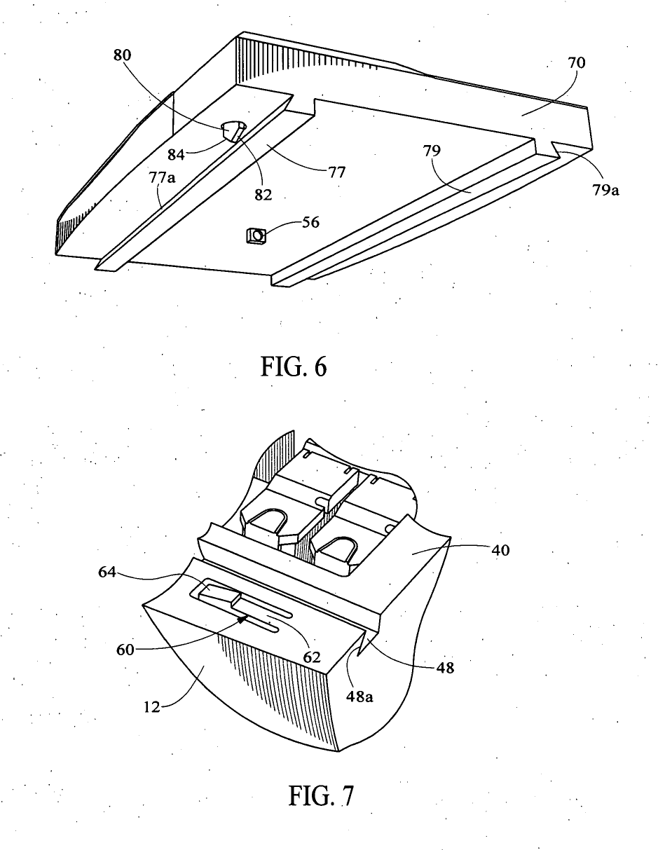

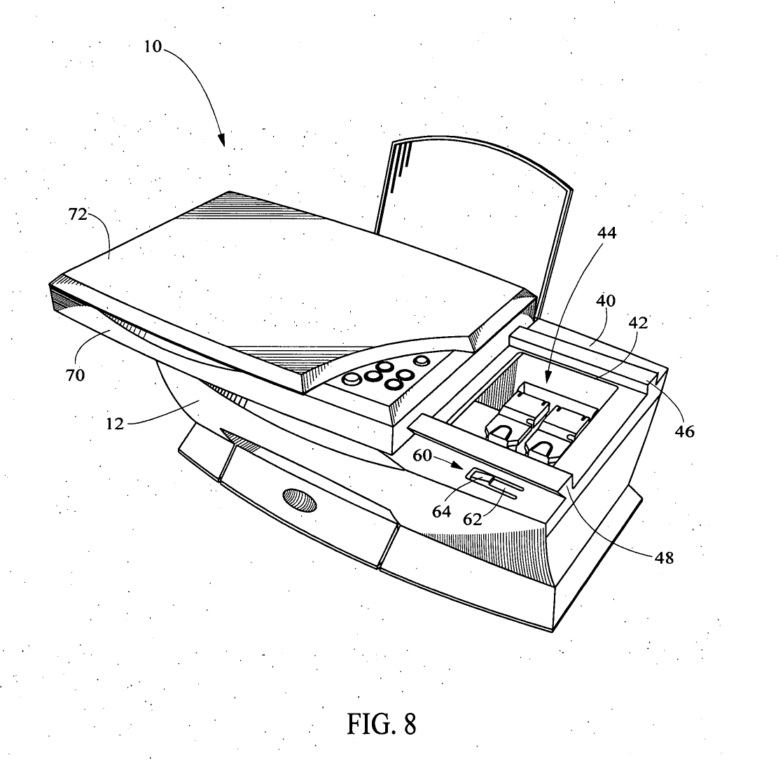

As shown in the illustrative embodiment of FIG. 7, tracks 46, 48 are each defined by three sides, at least one of which is tapered or beveled 46a, 48a. Tracks 46, 48 are preferably sized to closely receive corresponding scanner bed rails 77, 79 (see FIG. 6). The tapered side of the tracks 46, 48 engage a corresponding tapered side of scanner bed rails 77, 79 to inhibit vertical motion of the scanner bed 70. In other words, the tracks 46, 48 and scanner bed rails 77, 79 act as retainers to inhibit removal of the scanner bed 70 by vertical lifting motion, while allowing a generally horizontal sliding motion of the scanner bed 70 relative to the base housing 12. Alternatively, the tracks 46, 48 may have some alternative shape such as two tapered surfaces, forming a keyway, or a shape comprising at least one horizontal surface either of which may inhibit vertical removal of the scanner bed 70 but allow generally horizontal sliding motion between the scanner bed 70 and base housing 12. In a further alternative, the tracks 46, 48 may be positioned on the a lower surface of the scanner bed 70, as shown in FIG. 8 and are received into corresponding scanner bed rails formed into the scanner bed 70.

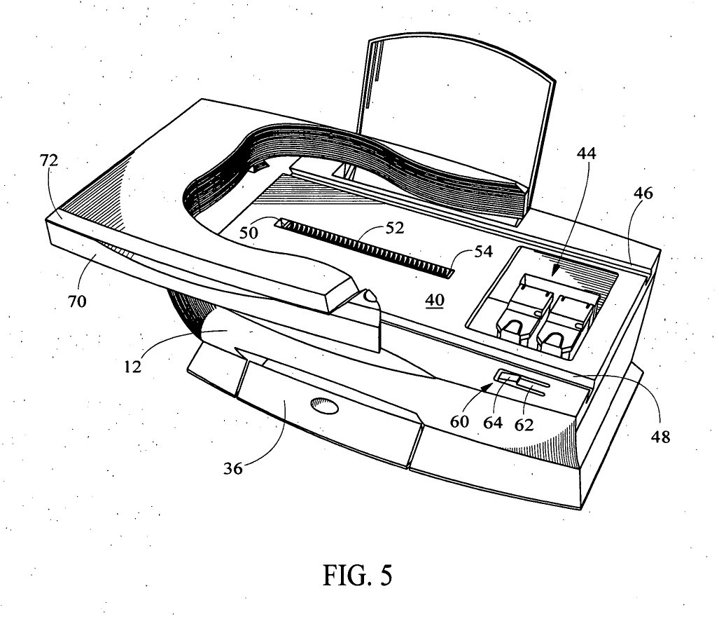

Referring now to FIGS. 3 and 5, a pocket 50 is also located within the base housing cover 40 for retaining a biasing spring 52. The spring pocket 50 may be semi-cylindrical or an elongated channel having a spring retention feature 54 therein for maintaining at least one end of the biasing spring 52 depending on whether the biasing spring 52 is a compression spring or an extension spring. The biasing spring 52 of the present exemplary embodiment is a compression spring as shown in FIG. 3 and is compressed when the scanner bed 70 is in a closed and operational position. As depicted in FIG. 6, a spring engaging clip 56 is shown depending from the scanner bed 70. The clip 56 may be various shapes but should have a portion which extends into the spring pocket 50 and engages the spring 52. The clip 56 of the present embodiment is substantially square in shape having a cross-section allowing the clip 56 to be slidably positioned within the pocket 50 and be engaged by spring 52. As previously indicated, when the scanner bed 70 is disposed in the closed and operational first position the biasing spring 52 is compressed as shown in FIG. 3. However, when the scanner bed 70 is in the open position, as shown in FIG. 5, the biasing spring 52 is extended. Alternatively, the spring characteristics would be reversed if an extension spring is used. Further, other biasing mechanisms may be utilized with varying constructions such that the bed may be biased when opened.

Referring now to FIGS. 2, 3, 5, and 7, the base cover 40 further comprises a snap hook or slide lock 60 comprising a tab 62 and a catch 64. The tab 62 is formed by removing cover material, in a substantially a U-shaped pattern, from three sides of the tab 62 resulting in a cantilevered tab design wherein a free end having the catch 64 will move downward. The tab 62 will flex downward from the position shown. At a distal end of the tab 62 is the tapered catch 64 which engages a lower surface of a cartridge change button or release button 80 depending through the scanner bed 70 and further described hereinafter. When the scanner bed 70 is disposed in the closed operational position shown in FIG. 1, the button 80 engages a vertical edge of the catch 64 so that the scanner bed is locked in the closed position preventing the generally horizontal sliding motion of the scanner bed 70. When moving from the open position shown in FIG. 2 to the closed position, the button 80 will engage the tapered portion of the catch 64 as the scanner bed 70 is slidably closed and the tab 62 will move downward until the button 80 locks on the vertical side of the catch 62. Other hooks or retention members may likewise be utilized to limit the generally horizontal sliding of the bed along the top of the housing 12.

Referring now to FIGS. 1-3 and 6, the scanner bed 70 is shown including a scanner lid 72 which is hingedly attached to the scanner bed 70. The lid 72 may be moved with respect to the scanner bed between a closed position shown in FIG. 2 and an open position shown in FIG. 1 revealing a transparent platen 76. The lid 72 may also include a material of a preselected color on the lower surface of lid 72 in order to provide increased contrast. An original document may be positioned beneath the scanner lid or cover 72 on the platen 76 for copying or scanning by the multifunction peripheral 10. Within the scanner bed 70 is an optical scanning unit having a plurality of parts which are not shown but generally described herein. The scanning unit comprises a scanning motor and drive which connects the scanning motor and a scan bar which is driven bi-directionally along a scanning axis which may be in the direction of the longer axis of the scanner bed. The scan bar may include a lamp, an image sensor, and a mirror therein for obtaining a scanned image from a document. The image sensor may be a contact image sensor (CIS) or a charge coupled device (CCD). In either event, the scan bar includes a flexible cable for receiving electrical communication signals and power for the lamp and image sensor located within the scan bar. At least one guide bar may be disposed within the scanner bed 70 and extending in the direction of the scanning axis to guide the scanning unit along the scanning axis. The scan bar moves within the scanner bed 70 beneath the platen 76 and the lamp illuminates the document positioned on the platen 76. For a CCD devices, mirrors and lenses located within the scan bar direct the image reflected from the document to the image sensor. The image sensor then determines the image and sends data representing the image to onboard memory, a network drive, or a PC or server housing a hard disk drive or an optical disc drive such as a CD-R, CD-RW, or DVD-R/RW. As is known in the art, a similar process occurs with the CIS-type of image sensor. Alternatively, the original document may be scanned by the optical scanning component and a copy printed from the printing component 14 such as with a multi-function peripheral.

Also located on the scanner bed 70 are a plurality of controls 78 including the cartridge change button 80. Use of the button 80 causes slidable release of the scanner bed 70 from the base housing 12 as well as causing the carrier 18 to move to the cartridge changing station 44 by way of an electrical contact or mechanical means. As shown in FIG. 6, a lower portion of the cartridge change button 80 includes as a first tapered surface 82 and a second tapered surface 84 which have an angle of about 90 degrees therebetween. The button 80 may be biased by for instance a coil spring in order to force the button to its original position after being depressed. When the button 80 is pressed, the lower portion of button 80 engages the snap hook 60 flexing the hook downward. The flexing of snap hook 60 together with the biasing force provided by the biasing spring 52 allows the second tapered surface 84 to pass over the catch 64 such that as the scanner bed 70 is slidably opened for cartridge changing and the button 80 will not hang-up on the catch 64 or the edge of the opening defining the slide lock 60. When closing, the first tapered surface 82 allows the scanner bed 70 to slide over the tapered surface of catch 64 allowing the second tapered surface 84 to engage with the catch 64 when scanner bed 70 reaches the closed position. Of course any electrical or mechanical removable retaining connection between the housing 12 and bed 70 may be utilized so long as the two are removably attached together while also allowing for the horizontal movement of the scanner bed 70.

In addition to the button release mechanism 80 previously described, alternative release mechanisms may be incorporated into the slidable scanner bed design of the image recording apparatus 10. For example, the button 80 may be an electrical button which actuates or signals a release solenoid or other electromagnetic type latch. In this design a spring loaded scanner bed 70 would still be used. Alternatively, the electrical button 80 could be used to release the scanner bed 70 and signal a motorized opening mechanism to open or close the scanner bed 70. An even further alternative design might incorporate a menu displayed with, for instance, a liquid crystal display (LCD). A user may select a cartridge change option by LCD screen menu which would release the scanner bed 70 using for instance a solenoid or other electromagnetic device. The scanner bed could then be opened in any of the previously described methods including manually, by spring bias, or for instance by motor.

Referring still to FIG. 6, depending from the scanner bed 70 may be first and second rails 77, 79. The rails 77, 79 provide a slidable connection between the scanner bed 70 and the housing cover 40. The first and second rails 77, 79 each include three sides including at least one angled side 77a, 79a. The rails 77, 79 are slidably positioned within the tracks 46, 48 respectively and the angled track walls slidably engage the angled sides 77a, 79a. The engaged angled surfaces 77a, 79a and the tracks 46, 48 inhibit removal of the scanner bed 70 by a vertical motion. The rails 77, 79 may be integrally molded or fastened to the lower surface of the scanner bed 70.

According to one alternative sliding mechanism depicted in FIG. 8, the rails may be formed to extend from an upper surface of the base housing 12 or base cover 40. In this design, the tracks are opposite the rails and formed in a lower surface of the scanner bed 70. In either embodiment, the rails, the tracks, or both the rails and tracks may have a damping grease applied thereon in order to provide a fluid dampened transition back and forth between the closed and opened position and to also provide the consumer with a high quality feel.

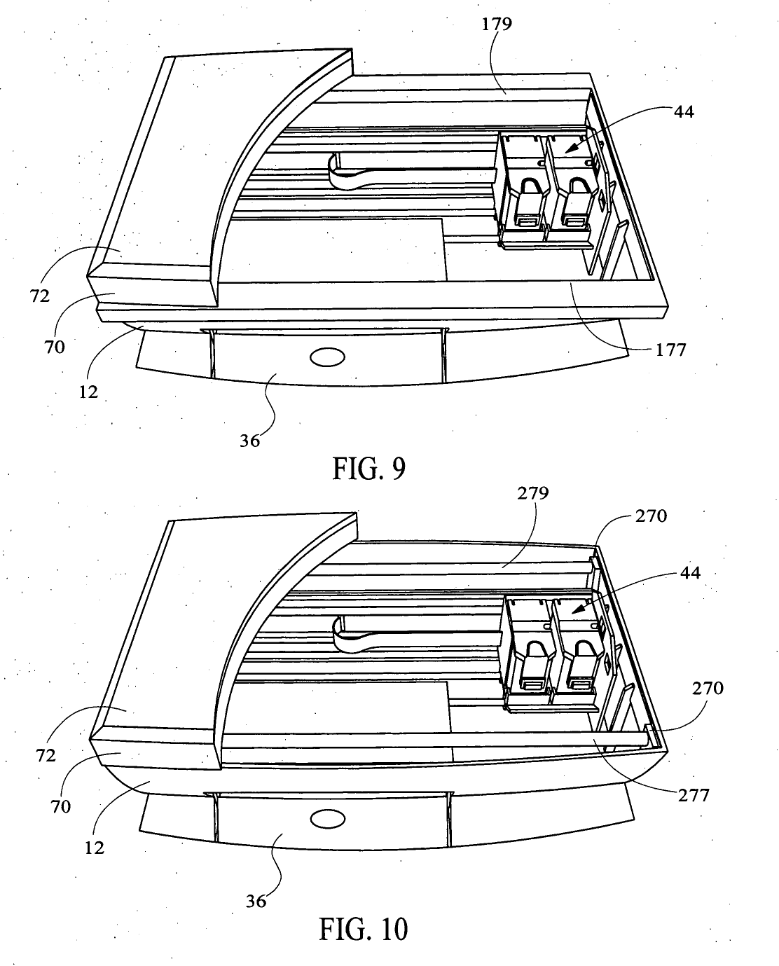

According to another alternative embodiment, it may be desirable to eliminate the base housing cover 40 to lower manufacturing costs. However, when the base cover 40 is eliminated, an alternative sliding mechanism to that previously described may be provided so that the scanner bed 70 will slide relative to the base housing 12. This is shown in FIG. 9 where, according to this embodiment, guide rails 177 and 179 may be formed in the front and rear edges of the base housing 12. More specifically, vertical walls 177, 179 are provided along the upper edges of the base housing portion 12. If the vertical walls are substantially parallel, rather than curvilinear, along the front and rear of the base housing 12, the vertical walls may be used as guide rails 177, 179 to guide the scanner bed 70 between open and closed positions. By using the vertical walls of the base housing 12 as guide rails 177, 179 rather than a housing cover, a substantial portion of the base housing cover (not shown) can be eliminated. A portion of the cover may be left to define a window for a cartridge changing station 44. By eliminating a large portion of the cover 40, a substantial manufacturing expense is reduced.

According to yet a further alternative of the sliding mechanism shown in FIG. 10, the base housing 12 may include posts 270 extending upward from the lower surface of the base portion 12. The posts 270 may be integrally molded within the base housing 12 or may be formed of sheet steel or otherwise separately formed and fastened to the base 12. According to this embodiment, extending between the posts 270 are scanner bed support guiding shafts 277, 279. The shafts may be formed of a plurality of shapes and provide for yet a further slidable type connection between the scanner bed 70 and base housing 12. Depending from a lower surface of the scanner bed may be bearing surfaces which are shaped to receive the guiding shafts 277, 279. The bearing surfaces may be integrally molded with the scanner bed 70 or may be formed separately and fastened to the lower surface of the scanner bed 70. According to this illustrative embodiment the horizontal sliding motion of the scanner bed 70 is retained relative to the base housing 12.

As an alternative to the spring loaded actuation system for the scanner bed 70, the scanner bed may be opened with various alternatives. First, the scanner bed 70 may be opened and closed by a motorized mechanism. As a second alternative, no actuation or biasing force may be provided so that the sliding motion of the scanner bed 70 is manually moved by the user. As a third alternative, magnetic-levitation style electromagnets may be used to actuate the scanner bed 70 between open and closed positions. By selectively energizing the electromagnets, the scanner bed 70 may be slidably urged in one direction or an alternate direction. In yet a further alternative, the scanner bar and scanner motor or the carrier may be used to actuate the scanner bed 70 to an open position. For instance a bar or post may be depending from the scanner bed 70 and may be engaged by the carrier 18 in order to push or pull the scanner bed 70 between the first and second positions. Alternatively, a bar depending from the scanner bar may depend downwardly in order to retain the scan bar in place and cause the scanner bed 70 to slide to either an open or closed position.

It is apparent that variations may be made to the slidable scanner bed design of the present invention in regards to specific design elements thereof. Such variations however are deemed to fall within the teachings of the present invention as generally modifications may be made to placement of the particular structure described herein while falling within the general teachings hereof.

1. A multi-function peripheral, comprising:
a base housing;
a scanner bed slidably positioned on said base housing; and,
said scanner bed being slidable between a first position and a second position, said second position revealing a cartridge changing station within said base housing.

2. The multi-function peripheral of claim 1 wherein said scanner bed further comprises a biasing mechanism interposed between said base housing and said scanner bed.

3. The multi-function peripheral of claim 1 further comprising rails depending from said scanner bed.

4. The multi-function peripheral of claim 3 further comprising tracks extending through said base and slidably engaging said rails.

5. The multi-function peripheral of claim 1 further comprising said base housing having a cover with at least one rail extending from said cover.

6. The multi-function peripheral of claim 5 further comprising at least one track positioned in a lower surface of said scanner bed and slidably receiving said at least one rail.

7. The multi-function peripheral of claim 1 further comprising said slidable scanner bed being moveable between a first closed position and a second open position.

8. The multi-function peripheral of claim 7 further comprising said open position revealing a cartridge changing station in said base housing.

9. The multi-function peripheral of claim 1 further comprising said scanner bed being horizontally slidable along said base housing.

10. The multi-function peripheral of claim 1 further comprising a scanner lid hingedly attached to said scanner bed.

11. A slidable scanner bed for an image recording apparatus, comprising:
a base housing;
a sliding mechanism connecting said base housing to a slidable scanner bed; and
an interface device interposed between said base housing and said scanner bed to limit travel of said scanner bed.

12. The slidable scanner bed of claim 11 further comprising said sliding mechanism having at least one rail depending from said scanner bed.

13. The slidable scanner bed of claim 12 wherein said sliding mechanism further comprises at least one track in said base housing slidably receiving said at least one rail.

14. The slidable scanner bed of claim 13 further comprising said at least one rail and said at least one track each having at least one interfacing angled surface inhibiting vertical disengagement of said slidable scanner bed from said base housing.

15. The slidable scanner bed of claim 11 further comprising at least one rail extending from said base housing and at least one track located within a lower surface of said scanner bed.

16. The slidable scanner bed of claim 11 wherein said sliding mechanism further comprises at least one guide shaft extending within said base housing.

17. The slidable scanner bed of claim 16 further comprising said scanner bed having at least one bearing surface receiving said guide shaft.

18. The slidable scanner bed of claim 11 wherein said interface device further comprises a button extending through said scanner bed.

19. The slidable scanner bed of claim 18 further comprising said button having a first tapered engagement surface at an end of said button adjacent said base housing.

20. The slidable scanner bed of claim 19 further comprising said button having a second tapered engagement surface.

21. The slidable scanner bed of claim 20 further comprising a snap hook formed in said base housing cover for engaging said button at one of said engagement surfaces.

22. The slidable scanner bed of claim 11 further comprising a cover extending across an upper opening in said base housing.

23. The slidable scanner bed of claim 22 further comprising said cover having a window therein.

24. The slidable scanner bed of claim 11 where said base housing further comprises a cover with said cover including at least one snap hook.

25. The slidable scanner bed of claim 24 further comprising a button extending through said scanner bed for engaging with said snap hook.

26. The slidable scanner bed of claim 11 further comprising said scanner bed having a biasing mechanism interposed between said scanner bed and said base housing.

27. The slidable scanner bed of claim 26 further comprising said base housing have a pocket therein and said biasing mechanism being a spring disposed within said pocket.

28. A slidable scanner bed for a multi-function peripheral, comprising:
a base housing;
an interface device releasing said scanner bed from a locked position; and,
a printing component positioned internally of said base housing.

29. The slidable scanner bed of claim 28 further comprising at least one rail depending from said scanner bed slidably engaging at least one track molded in said base housing.

30. The slidable scanner bed of claim 29 further comprising said at least one rail being first and second rails and said at least one track being corresponding first and second tracks.

31. The slidable scanner bed of claim 29 further comprising said first and second rails depending from said scanner bed.

32. The slidable scanner bed of claim 28 further comprising at least one rail extending from said base housing and slidably engaging at least one track formed in a lower surface of said scanner bed.

33. The slidable scanner bed of claim 28 further comprising a housing cover on said base housing having a window revealing a cartridge changing station of said printer component.

34. The slidable scanner bed of claim 33 further comprising said housing cover having a slide lock comprising a tab and a tapered catch, said slide lock retaining said scanner bed in a closed position.

35. The slidable scanner bed of claim 28 further comprising a biasing device urging said scanner bed from a first position to a second position.

36. The slidable scanner bed of claim 35 further comprising said base housing having a pocket therein and said biasing device comprising a biasing spring positioned in said pocket.

37. The slidable scanner bed of claim 36 further comprising said scanner bed having a clip depending therefrom for engaging said biasing spring.

38. The slidable scanner bed of claim 28 further comprising said base housing having posts therein and guide shafts positioned between said posts.

39. The slidable scanner bed of claim 38 further comprising bearing members depending from said scanner bed and slidably engaging said guide shafts.

40. The slidable scanner bed of claim 28 further comprising a sliding mechanism defined by vertical walls extending from and upper portion of said base housing along a front edge and a rear edge.

41. The slidable scanner bed of claim 40 further comprising said front edge and said second edge being substantially parallel.

42. The slidable scanner bed of claim 28 further comprising said interface device comprising a spring loaded button.

43. The slidable scanner bed of claim 28 wherein said interface device further comprises a push-button actuated electric solenoid.

44. The slidable scanner bed of claim 28 wherein said interface device further comprises a push-button actuated electromagnetic latch.

45. The slidable scanner bed of claim 28 wherein said interface device further comprises a motorized opening mechanism and an electrical push-button, said electrical push-button actuating said motorized opening mechanism.

46. The slidable scanner bed of claim 1, said scanner bed being actuated by a motor.

47. The slidable scanner bed of claim 1 further comprising an actuable electromagnet for moving said scanner bed from a first position to a second position.

48. The slidable scanner bed of claim 28 further comprising said scanner bed being manually slidably operated between open and closed positions.
